(19) United States
(12) Patent Application Publication
(10) Pub. No.: US 2006/0275523 A1
(43) Pub. Date: Dec. 7, 2006

(54) Distribution block for blown-film extrusion die

(76) Inventor: Domenico Marzano, Woodbridge (CA)

Correspondence Address: STANDLEY LAW GROUP LLP, 495 METRO PLACE SOUTH, SUITE 210, DUBLIN, OH, 43017, US

(21) Appl. No.: 11/142,413

(22) Filed: Jun. 2, 2005

(51) Int. Cl. B29C 47/06

(52) U.S. Cl. 425/133.1

(57) ABSTRACT

A melt distribution block for a co-extrusion die has a generally annular body, for example in the shape of a conical frustum. The annular body has opposed front and rear faces and opposed inner and outer faces. Inlets at the outer face have channel ports for accepting flow of melted polymer into the distribution block. Flow controlling valves independently control the flow of the melted polymer through each of the channel ports. Melt flow channels on the front and rear faces between the inner and outer faces are in fluid communication with the channel ports. A thermal insulation layer within the distribution block between the front and rear faces separate all or part of the melt flow channels on the front face from all or part of the melt flow channels on the rear face. Such blocks together with separator blocks may be axially stacked front to rear around a central mandrel to form an extrusion die suitable for making blown films into tubular form.

### FIELD OF THE INVENTION

The present invention relates to distribution blocks and co-extrusion dies for extruding polymer materials into a single tubular form.

### BACKGROUND OF THE INVENTION

Annular co-extrusion dies comprising a plurality of stacked distribution blocks for producing multi-layer blown-films are known in the art. Examples of such dies, and distribution blocks for such dies, are disclosed in Canadian Patents 2,198,038 and 2,308,128 and United States Patent Publication 2002/0114858, among others. Distribution blocks for annular dies may be generally flat, as in Canadian Patent 2,308,128 and United States Patent Publication 2002/0114858, or may be conical, as in Canadian Patent 2,198,038.

Current dies, whether using flat or conical distribution blocks, suffer from a lack of versatility. With increasingly varied applications for multi-layer blown films, a single die is often not enough to produce the great variety of multi-layered films required. Manufacturers are forced to build and maintain several different dies for different applications, or add and remove blocks from existing dies, thereby increasing capital and operating costs and reducing the manufacturer's ability to change product focus quickly in response to market place demands.

It would be beneficial to provide a single multi-layer blown-film co-extrusion die that can be used to produce a larger variety of multi-layer blown-films for a greater variety of applications without changing or adding distribution blocks, and without constructing entirely new dies.

### SUMMARY OF THE INVENTION

There is provided a melt distribution block for a co-extrusion die comprising: a generally annular body having opposed front and rear faces and opposed inner and outer faces, the outer face located radially outward of the inner face; one or more inlets at the outer face for accepting flow of melted polymer into the distribution block and one or more outlets at the inner face for permitting flow of the polymer out of the distribution block into an extrusion passage of the die; melt flow channels on the front and rear faces between the inner and outer faces in fluid communication with the one or more inlets and the one of more outlets; and, a thermal insulation layer within the distribution block between the front and rear faces separating all or part of the melt flow channels on the front face from all or part of the melt flow channels on the rear face.

There is further provided an extrusion die for manufacturing blown polymer film in tubular form comprising a plurality of melt distribution blocks of the present invention stacked axially front to rear interspersed with separator blocks extending radially about a centrally disposed mandrel to define an extrusion passage between the mandrel and the stack of distribution and separator blocks.

A melt distribution block of the present invention has a generally annular body. The annular body may be flat, generally in the shape of a disc, or, it may comprise a conical frustum in which the front and rear faces are elevated at an angle away from horizontal. Preferably, the annular body comprises a conical frustum. Preferably, the front and rear faces are elevated at the same angle of elevation from horizontal. Preferably, the angle of elevation is in a range from about 2° to about 20°, more preferably from about 5° to about 15°.

The opposed inner and outer faces are preferably concentric, the distribution block having an aperture in the center circumscribed by the inner face. The opposed front and rear faces are preferably generally parallel to each other, whether the annular body is disc-shaped or comprises a conical frustum.

At the outer face, there are one or more inlets for accepting flow of melted polymer into the distribution block, typically from an external source such as an extruder. In order to control the flow of melted polymer through an inlet, flow controlling means may be associated with the inlet. Flow controlling means advantageously permits adjustment of flow rate to compensate for partial blockages, for viscosity differences, etc. that may affect the flow rate of the polymer melt during operation. The inlet may be in fluid communication with melt flow channels on one or both of the front and rear faces. Where an inlet feeds melted polymer into only one of the front or rear faces, the other face may be fed melted polymer through another inlet.

A single inlet may comprise one or more channel ports through which melted polymer can be fed into the distribution block. If an inlet comprises more than one channel port, one channel port may feed the melt flow channels on the front face while another may feed the melt flow channels on the rear face. In this manner, more than one type of polymer may be fed into a single distribution block to ultimately form multi-layer films. Flow of melted polymer through each channel port may be controlled independently by flow controlling means. The inlet may be provided with insulation between channel ports for thermally isolating the channel ports. Each channel port may be provided with a separate heater.

The flow controlling means may be internal to the inlet (e.g. in the channel ports) or may be a separate unit located radially outward of the outer face and fluidly connected to the inlet or inlets. Where the flow controlling means is located radially outward of the outer face, the flow controlling means may be mounted to the distribution block, for example on the outer face, or mounted somewhere else and fluidly connected to the inlet, for example by conduits. The flow controlling means may be, for example, a valve or valves. Independent control of melt flow through multiple channel ports within an inlet advantageously provides great versatility in the types of polymer resins that may be used in extrusion dies comprising distribution blocks of the present invention. The flow controlling means may be provided with insulation to thermally isolate melt flows through the multiple channel ports. The flow controlling means may be provided with a heater or heaters to commonly or independently control the temperature of the melt flow or flows.

The front and rear faces have melt flow channels thereon. The melt flow channels preferably comprise flow divider channels and spiral channels as described in U.S. Pat. No. 6,343,919, issued Feb. 5, 2002 to Rodriguez et al. or United States Patent Publication 2002/0114858, published Aug. 22, 2002 in the name of Castillo, the disclosures of which are herein incorporated by reference.

The flow divider channels are in fluid communication with the one or more inlets and extend generally inward toward the inner face from the one or more inlets to terminate in the spiral channels. The flow divider channels preferably comprise a series of bifurcations where melted polymer is divided and recombined to enhance mixing and homogeneity of the polymer flow. Flow divider channels on the front face are preferably separate from those on the rear face.

The flow divider channels terminate in one or more spiral channels, preferably four spiral channels. The spiral channels narrow radially inward toward the inner face to terminate at one or more outlets, each spiral channel substantially encircling the inner face. Lands between the spiral channels become increasingly less high to permit polymer to flow over the lands which further enhances mixing. Polymer flow on the front face is eventually combined with polymer flow on the rear face after the flows exit the spiral channels.

Where the distribution block comprises a conical frustum, inclusion of melt flow channels on both the front and rear faces has been a problem in the art. In conical dies, channels are normally only found on the convex surface since including channels on the concave surface is problematic. The present invention successfully includes melt flow channels on both the convex and concave surfaces, which enhances the effectiveness of the block and the homogeneity of the resultant film. Providing an annular body having a conical frustum with an angle of elevation in a range from about 2° to about 20° contributes to the success in providing melt flow channels on both the concave and convex surfaces of the conical frustum.

The distribution block may comprise one or more heating means for heating the block to help prevent the melted polymer from solidifying in the block. Preferably, the front face is heated separately from the rear face by separate heating means that can be independently controlled. The heating means may be, for example, an electrical resistance heating coil or strip or cartridge heaters. Preferably, the heating means is annular and is attached to the outer face, for example by clamps. Thereby heating the distribution block from the outside in. Use of heating means to independently control the temperature on the front and rear faces advantageously provides greater versatility in the types of polymer resins that may be used in extrusion dies comprising distribution blocks of the present invention.

The distribution block comprises a thermal insulation layer within the distribution block between the front and rear faces separating all or part of the melt flow channels on the front face from all or part of the melt flow channels on the rear face. If two or more heating means are used to independently control the temperature on the front and rear faces, the thermal insulation layer preferably separates the heating means that controls temperature on the front face from the heating means that controls temperature on the rear face. The thermal insulation layer within the block may comprise a fluid filled chamber and/or a solid insulation element. The thermal insulation layer is preferably generally annular and preferably equally axially distant from the front and rear faces. Preferably the thermal insulation layer comprises a fluid filled chamber. Fluids may comprise a liquid or a gas, for example, air, nitrogen, water, ethylene glycol, mixtures thereof, etc. Preferably, the fluid is air or water. In one embodiment, the thermal insulation layer comprises a fluid filled chamber and a solid insulation element. The fluid filled chamber may separate the melt flow channels on the front face from those on the rear face while the solid insulation element separates the front face from the rear face near the outer face. The solid insulation element may comprise any suitable material, for example, ceramic, fiberboard, etc.

The thermal insulation layer advantageously provides greater versatility in the types of polymer resins that may be used in extrusion dies comprising distribution blocks of the present invention. By thermally segregating the front face from the rear face, a different type of polymer resin having a different melt profile may flow through the channels on the front face without thermal interference from or thermally interfering with the polymer resin flowing through the channels on the rear face. This feature coupled with multiple channel ports in a single inlet and independently controlled heating means for the front and rear faces provides an exceptionally versatile distribution block for use in co-extrusion dies, especially co-extrusion dies for forming multi-layered films. The ability to physically and thermally separate polymer melt flows within a single distribution block permits construction of a single die that can handle a variety of different applications. For example, a die with seven stacked distribution blocks of the present invention could produce films having any number of layers from 1 to 14.

The fluid filled chamber may be in fluid communication with fluid circulating means, for example a pump, for re-circulating the fluid through the chamber. Re-circulated fluid may be passed through a heat exchanger for adjusting the temperature of the fluid. The fluid filled chamber may be in fluid communication with the outside of the block by means of conduits from the chamber to apertures in the outer face of the block.

In order to introduce the thermal insulation layer into the distribution block, the distribution block may be initially manufactured in separate front and rear sections. A fluid filled chamber may be formed by a groove or grooves machined into the backside of the front and/or rear sections. If fluid circulation is desired, circulation conduits leading from the groove or grooves to the outer face may also be included. Solid insulation elements may be introduced by machining a groove or grooves into the backside of the front and/or rear sections and then filling the groove or grooves with the solid insulation element. The separate sections can then be attached together, preferably by welding or fasteners (e.g. bolts).

In an extrusion die, a plurality of distribution blocks are stacked axially front to rear interspersed with separator blocks extending radially about a centrally disposed mandrel to define an extrusion passage between the mandrel and the stack of distribution and separator blocks. Separator blocks provide faces that oppose the front and rear faces of the distribution blocks thereby enclosing the melt flow channels of each distribution block. A separator block may also be designed to provide a face for opposing the inner face of a distribution block in order to provide an exit channel for conveying melt flow from the outlet of the distribution block to the extrusion passage of the die. In the extrusion die, the flow of melted polymer from the front face of one distribution block may be combined in the exit channel with the flow of melted polymer from the rear face of the same distribution block before melted polymer flows into the extrusion passage. Separator blocks may also be manufactured having thermal insulation layers therein.

As is known in the art, air blown upwards into the extrusion passage cools and solidifies the polymer melt flowing out of each distribution block and causes the polymer flows from each distribution block to combine into a multi-layered blown polymer film in tubular form. By providing different polymers in one or more of the distribution blocks, or by providing a different polymer in the front faces as opposed to the rear faces of one or more of the distribution blocks, it is possible to manufacture blown polymer films having a plurality of different layers. Blown film extruded from the co-extrusion die may be further processed in a manner known to one skilled in the art.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a perspective view of a melt distribution block of the present invention;

FIG. 2 is a side cross-sectional view of the melt distribution block of FIG. 1;

FIG. 3 is a cut-away of a perspective view of the melt distribution block of FIG. 1 together with an alternate embodiment of flow controlling means attached to the outer face of the distribution block;

FIG. 4A is a side schematic view of the valve stem depicted in FIG. 1;

FIG. 4B is a side schematic view of the valve stem depicted in FIG. 3;

FIG. 5 is a side plan cross-sectional view of a co-extrusion die comprising an axially stacked plurality of distribution blocks of the present invention together with separator blocks; and,

FIG. 6 is a perspective cross-sectional view of the die depicted in FIG. 5.

### DESCRIPTION OF PREFERRED EMBODIMENTS

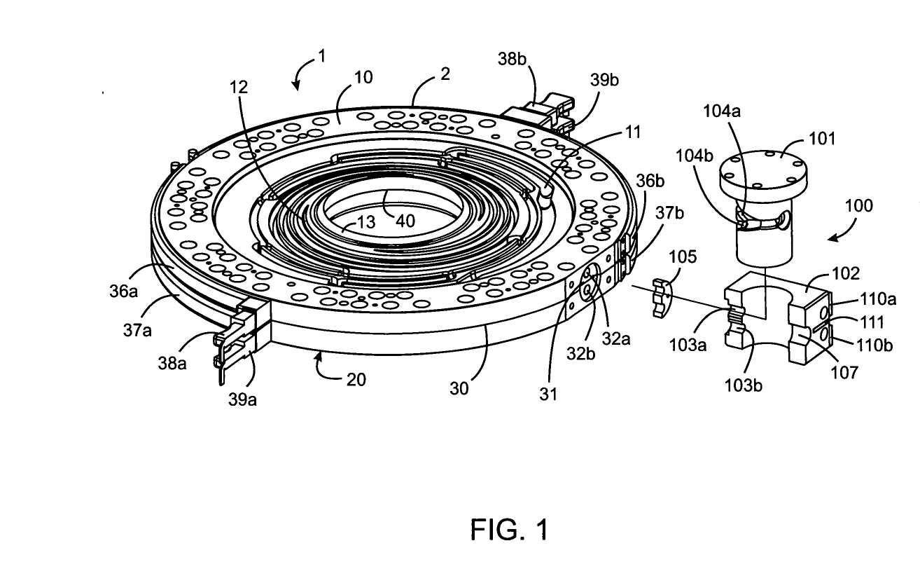

Referring to FIG. 1, distribution block 1 is depicted together with valve 100 for controlling flow of melted polymer into the distribution block. Distribution block 1 comprises generally annular body 2 having front face 10 and opposed rear face 20. Annular body 2 is manufactured in two halves welded together, one half having front face 10 and the other half having rear face 20. Annular body 2 also comprises outer face 30 and opposed inner face 40 located radially inward of the outer face.

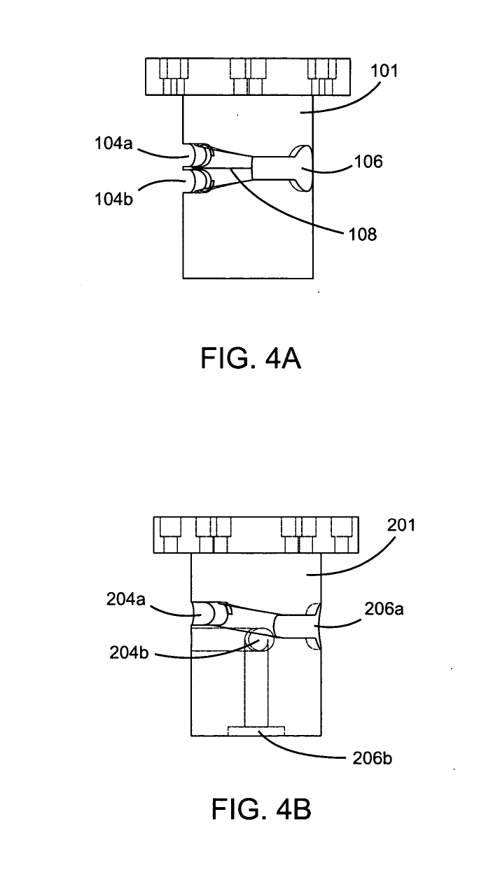

Inlet 31 on outer face 30 comprises front and rear channel ports 32a,32b for accepting a flow of melted polymer into the distribution block. Front channel port 32a feeds front face 10 and rear channel port 32b feeds rear face 20. Valve 100 comprises valve stem 101 rotatably seated in valve seat 102. Valve stem 101 is shown being inserted into valve seat 102 from the top; alternatively, the valve stem may be inserted into the valve seat from the bottom. Valve seat 102 is attached to outer face 30 over inlet 31 and valve spacer 105 so that channel ports 32a,32b are aligned with first and second valve seat exit ports 103a,103b. Valve 100 simultaneously and equally controls flow of polymer into both channel ports 32a,32b. Rotation of valve stem 101 in valve seat 102 adjusts alignment of first and second valve stem exit ports 104a,104b with front and rear channel ports 32a,32b thereby adjusting the amount of melt flow from the stem exit ports through the valve seat exit ports into the channel ports. Valve seat 102 further comprises heaters 110a,110b for controlling temperature of melt flow in valve seat exit ports 103a,103b, respectively. Valve seat 102 also comprises valve seat insulation element 111 to thermally isolate valve seat exit ports 103a and 103b from each other. For clarity, valve 100 is depicted detached from distribution block 1, and valve seat 102 and spacer 105 are depicted in cross-section. Further description of valve stem 101 is provided in respect of FIG. 4A described below.

Semicircular heating elements 36a and 37a for heating front face 10 and rear face 20 respectively are attached to outer face 30 by clamps 38a and 39a respectively. A section of the heating elements 36a and 37a and half of the clamps 38a and 39a have been omitted from FIG. 1 to illustrate the appearance of outer face 30 beneath the heating elements. A similar set of semicircular heating elements 36b,37b and clamps 38b,39b are located on outer face 30 on the other side of the distribution block so that the front and rear faces of the distribution block are heated substantially around the perimeter of the distribution block.

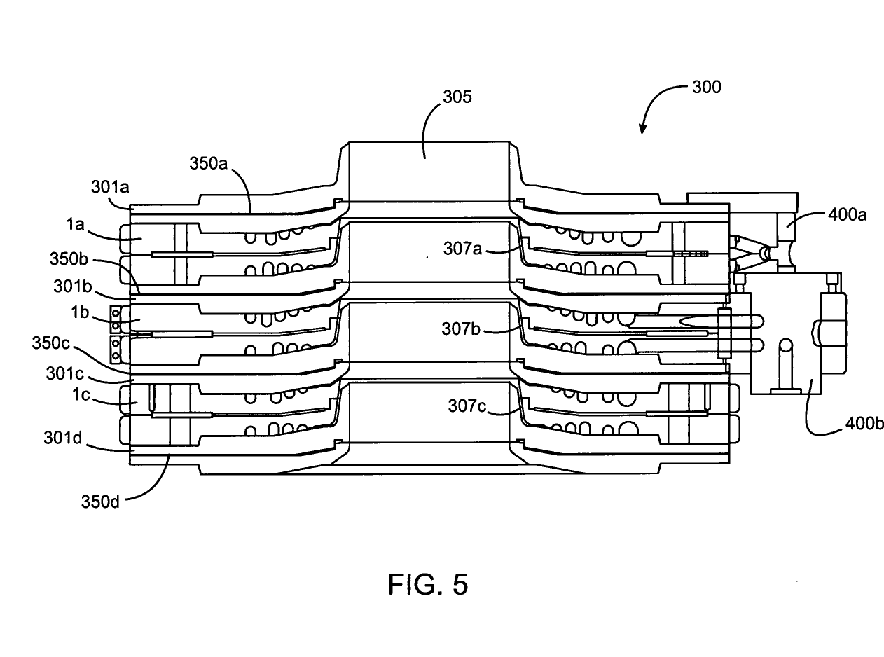

Front face 10 comprises melt flow channels, including flow divider channels 11 and spiral channels 12. Polymer flowing through channel port 32a enters flow divider channels 11 where the polymer flow undergoes a series of bifurcations and recombinations. From the flow divider channels, polymer flows into four spiral channels 11 that narrow radially inward and substantially encircle inner face 40. Polymer also flows over lands separating the spiral channels as the polymer flow moves radially inward. Finally, polymer flows out of the spiral channels and over final land 13. A similar description may be considered for melt flow channels on rear face 20. Further explanation of polymer flow in a co-extrusion die is provided in respect of FIG. 5 described below.

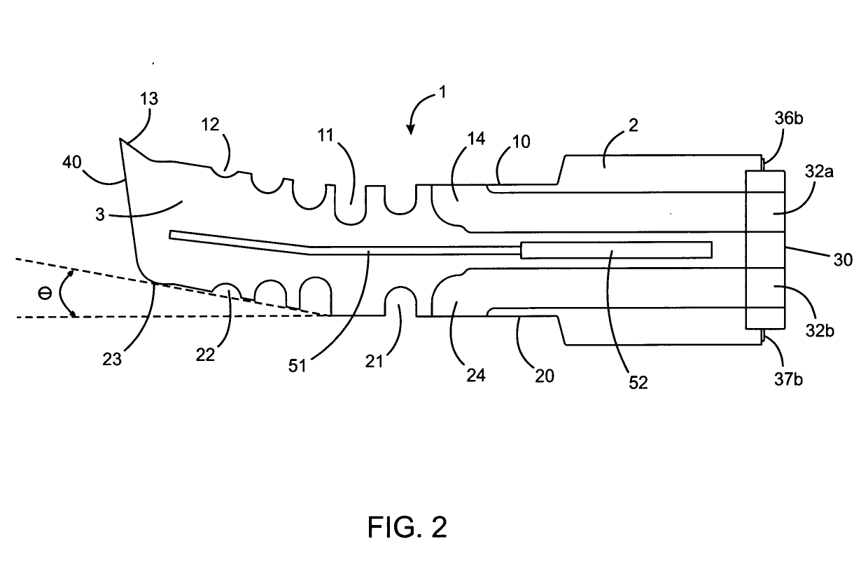

Referring to FIG. 2, a side cross-sectional view of melt distribution block 1 is depicted without the valve. On outer face 30, front and rear channel ports 32a,32b lead into melt flow channels 14,24 in front face 10 and rear face 20, respectively. Radially inward toward inner face 40, the melt flow channels comprise flow divider channels 11,21 on front and rear faces 10,20 respectively, and spiral channels 12,22 on front and rear faces 10,20 respectively. Polymer flowing through the melt flow channels flows radially inward and exits the distribution block at inner face 40 over final lands 13,23 on front and rear faces 10,20 respectively. Semicircular heating elements 36b,37b are attached to outer face 30 to heat front and rear faces 10,20 respectively.

Front and rear faces 10,20 of annular body 2 of distribution block 1 are generally horizontal near outer face 30 but are elevated by an angle θ of about 10° near inner face 40 to form a conical frustum 3. Front and rear faces 10,20 remain generally parallel to each other throughout the conical and horizontal portions of the annular body.

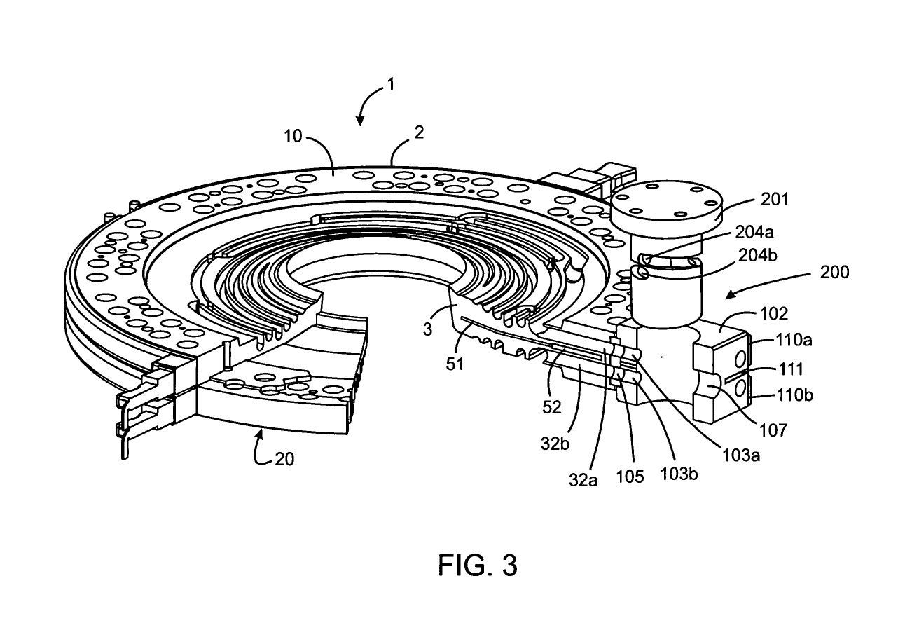

Referring to FIG. 3, melt distribution block 1 is depicted together with a different valve 200, and is depicted having a section of the block cut-away. Within annular body 2 there is a thermal insulation layer comprising annular air-filled chamber 51 and annular insulation disk 52. Annular insulation disk 52 comprises Polypel™, a polyimide fiberboard from Albany International. The thermal insulation layer is about equidistant from front face 10 and rear face 20. Air-filled chamber 51 generally follows the angle of elevation of conical frustum 3. Valve 200 permits separate control of melt flow into front and rear channel ports 32a,32b. Valve 200 comprises valve seat 102 and spacer 105 as described in respect of FIG. 1. Valve 200 also comprises valve stem 201 for permitting separate flow of different polymers into front and rear channel ports 32a,32b. Rotation of valve stem 201 in valve seat 102 adjusts alignment of first and second valve stem exit ports 204a,204b with front and rear channel ports 32a,32b respectively, thereby adjusting the amount of melt flow from each of the stem ports through each of the seat ports into each of the channel ports. Valve stem 201 is shown being inserted into valve seat 102 from the top; alternatively, the valve stem may be inserted into the valve seat from the bottom. Further description of valve stem 201 is provided in respect of FIG. 4B described below.

Referring to FIG. 1 and FIG. 4A, valve stem 101 depicted in FIG. 1 controls flow of melted polymer from a single source (e.g. one extruder) into both the front and rear channel ports 32a,32b in outer face 30 of annular body 2 of distribution block 1. Melted polymer from a single source flows through valve seat entry port 107 (see FIG. 1) into valve stem entry port 106 and the flow is divided into two streams by flow splitter 108. Flow splitter 108 is a wall dividing first stem exit port 104a from second valve stem exit port 104b. Polymer flows through first valve stem exit port 104a through first valve seat exit port 103a into front channel port 32a and onward to front face 10 of the distribution block. Likewise, polymer flows through second valve stem exit port 104b through second valve seat exit port 103b into rear channel port 32b and onward to rear face 20 of the distribution block. Rotation of valve stem 101 in valve seat 102 adjusts alignment of first and second valve stem exit ports 104a,104b with first and second valve seat exit ports 103a,103b respectively, thereby adjusting the amount of polymer flowing into front and rear channel ports 32a,32b respectively.

Referring to FIG. 3 and FIG. 4B, valve stem 201 depicted in FIG. 3 controls flow of melted polymer from two separate sources (e.g. two extruders) separately into the front and rear channel ports 32a,32b. Polymer flow from one polymer source flows through valve seat entry port 107 of valve seat 102 (see FIG. 3) into valve stem 201 through first valve stem entry port 206a and then out of the valve stem through first valve stem exit port 204a on its way to front channel port 32a and then to front face 10 of the distribution block. Polymer flow from another polymer source flows into valve stem 201 through second valve stem entry port 206b and then out of the valve stem through first valve stem exit port 204b on its way to rear channel port 32b and then to rear face 20 of the distribution block. Rotation of valve stem 201 in valve seat 102 adjusts alignment of first and second valve stem exit ports 204a,204b with first and second valve seat exit ports 103a,103b respectively, thereby adjusting the amount of polymer flowing into front and rear channel ports 32a,32b. In this way, the flow of two separate polymers from two separate polymer sources into the front and rear faces of a single distribution block may be controlled.

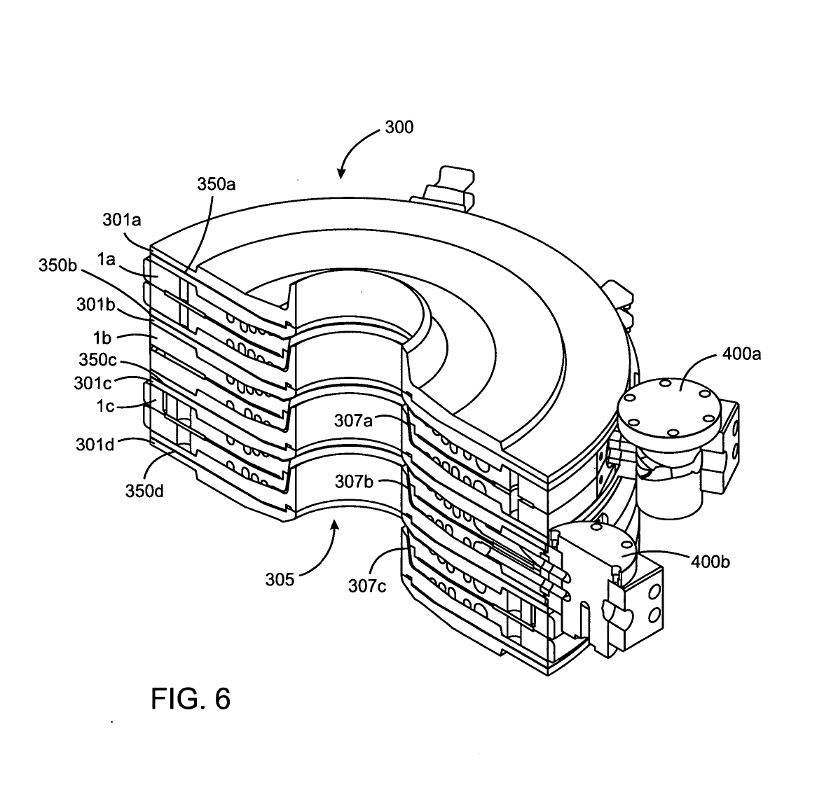

Referring to FIGS. 5 and 6, a co-extrusion die 300 comprises three axially stacked distribution blocks 1a,1b,1c interspersed by four axially stacked generally annular separator blocks 301a,301b,301c,301d. Each of the three distribution blocks has a valve 400a,400b (and one not shown) for controlling melt flow into the front and rear faces of each distribution block. Valve 400a is of the type described in FIG. 4A and valve 400b is of the type described in FIG. 4B. Each of the front and rear faces of each of the three distribution blocks is heated by heating elements and each of the three distribution blocks comprise an insulation layer between the front and rear faces. Each of the separator blocks also comprises an insulation layer 350a,350b,350c,350d.

A centrally disposed mandrel (not shown) occupies passage 305 created by central apertures in the stacked distribution and separator blocks. The distribution blocks are stacked front to rear so that conical portions of each of the distribution blocks are inclined in the same direction. The separator blocks comprise conical portions corresponding to the conical portions of distribution blocks. Recombination passages 307a,307b,307c are formed between inner faces of the distribution blocks and one face of inner ends of three of the separator blocks. Another face of the inner ends of the separator blocks also define an annular extrusion passage between the central mandrel (not shown) and the stack of separator blocks. The annular extrusion passage is located within passage 305 between the mandrel (not shown) and separator blocks.

Polymer flow exiting the front and rear faces of each distribution block over the final lands enters the recombination passage where separate flows from the front and rear faces are recombined into a single recombined flow. The recombined flow from each distribution block enters the extrusion passage. Air is blown into the extrusion passage from underneath the die thereby cooling melted polymer flow from each distribution block. Cooled polymer from one distribution block is layered over top of the cooled polymer from the distribution blocks below to form a multi-layered tubular film structure which is forced by the blown air out through the top of the die where the tubular film is collected and processes further.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A melt distribution block for a co-extrusion die comprising:
(a) a generally annular body having opposed front and rear faces and opposed inner and outer faces, the outer face located radially outward of the inner face;
(b) one or more inlets at the outer face for accepting flow of melted polymer into the distribution block and one or more outlets at the inner face for permitting flow of the polymer out of the distribution block into an extrusion passage of the die;
(c) melt flow channels on the front and rear faces between the inner and outer faces in fluid communication with the one or more inlets and the one of more outlets; and,
(d) a thermal insulation layer within the distribution block between the front and rear faces separating all or part of the melt flow channels on the front face from all or part of the melt flow channels on the rear face.

2. The distribution block of claim 1, wherein the thermal insulation layer is a fluid filled chamber.

3. The distribution block of claim 2, wherein the chamber is generally annular and is equally axially distant from the front and rear faces.

4. The distribution block of claim 2, wherein the chamber is in fluid communication with fluid circulating means.

5. The distribution block of claim 1, wherein the annular body comprises a conical frustum having an angle of elevation in a range of from 2° to 20°.

6. The distribution block of claim 1, further comprising flow controlling means for controlling flow of the melted polymer through the one or more inlets.

7. The distribution block of claim 1, wherein the one or more inlets each comprise two channel ports, a first channel port for feeding the melted polymer into the melt flow channels on the front face and a second channel port for feeding the melted polymer into the melt flow channels on the rear face.

8. The distribution block of claim 7, further comprising flow controlling means for independently controlling flow of the melted polymer through the first and second channel ports.

9. The distribution block of claim 8, wherein the flow controlling means is located radially outward of the outer face.

10. The distribution block of claim 1, wherein the melt flow channels comprise flow divider channels and spiral channels, the flow divider channels extending generally radially inward toward the inner face from the one or more inlets to terminate in the spiral channels, the spiral channels narrowing radially inward toward the inner face to terminate at the one or more outlets, each of the spiral channels substantially encircling the inner face.

11. A melt distribution block for a co-extrusion die comprising:
(a) a generally annular body comprising a conical frustum having opposed front and rear faces and opposed inner and outer faces, the outer face located radially outward of the inner face;
(b) one or more inlets at the outer face each comprising two channel ports for accepting flow of melted polymer into the distribution block and one or more outlets at the inner face for permitting flow of the polymer out of the distribution block into an extrusion passage of the die;
(c) flow controlling means for independently controlling flow of the melted polymer through each of the channel ports;
(d) melt flow channels on the front and rear faces between the inner and outer faces, the melt flow channels on the front face in fluid communication with a first channel port of the two channel ports, the melt flow channels on the rear face in fluid communication with a second channel port of the two channel ports, the melt flow channels comprising flow divider channels and spiral channels, the flow divider channels extending generally radially inward toward the inner face from the channel ports to terminate in the spiral channels, the spiral channels narrowing radially inward toward the inner face to terminate at the one or more outlets, each of the spiral channels substantially encircling the inner face; and,
(e) a thermal insulation layer within the distribution block between the front and rear faces separating all or part of the melt flow channels on the front face from all or part of the melt flow channels on the rear face.

12. The distribution block of claim 11, wherein the thermal insulation layer is a fluid filled chamber.

13. The distribution block of claim 12, wherein the chamber is generally annular and is equally axially distant from the front and rear faces.

14. The distribution block of claim 12, wherein the chamber is in fluid communication with fluid circulating means.

15. The distribution block of claim 12, wherein the conical frustum has an angle of elevation in a range of from 2° to 20°.

16. The distribution block of claim 12, wherein the flow controlling means is located radially outward of the outer face.

17. An extrusion die for manufacturing blown polymer film in tubular form comprising
a plurality of melt distribution blocks stacked axially front to rear interspersed with separator blocks extending radially about a centrally disposed mandrel to define an extrusion passage between the mandrel and the stack of distribution and separator blocks,
each distribution block comprising: a generally annular body having opposed front and rear faces and opposed inner and outer faces, the outer face located radially outward of the inner face; one or more inlets at the outer face for accepting flow of melted polymer into the distribution block and one or more outlets at the inner face for permitting flow of the polymer out of the distribution block into the extrusion passage; melt flow channels on the front and rear faces between the inner and outer faces in fluid communication with the one or more inlets and the one of more outlets; and, a thermal insulation layer within the distribution block between the front and rear faces separating all or part of the melt flow channels on the front face from all or part of the melt flow channels on the rear face.

18. The die of claim 17, wherein the thermal insulation layer is a generally annular fluid filled chamber.

19. The die of claim 18, wherein the annular body comprises a conical frustum having an angle of elevation in a range of from 2° to 20°.

20. The die of claim 19, wherein melted polymer from the front face is combined with melted polymer from the rear face before the polymer flows into the extrusion passage.

21. An extrusion die for manufacturing blown polymer film in tubular form comprising
a plurality of melt distribution blocks stacked axially front to rear interspersed with separator blocks extending radially about a centrally disposed mandrel to define an extrusion passage between the mandrel and the stack of distribution and separator blocks,
each distribution block comprising: a generally annular body comprising a conical frustum having opposed front and rear faces and opposed inner and outer faces, the outer face located radially outward of the inner face; one or more inlets at the outer face each comprising two channel ports for accepting flow of melted polymer into the distribution block and one or more outlets at the inner face for permitting flow of the polymer out of the distribution block into the extrusion passage; flow controlling means for independently controlling flow of the melted polymer through each of the channel ports; melt flow channels on the front and rear faces between the inner and outer faces, the melt flow channels on the front face in fluid communication with a first channel port of the two channel ports, the melt flow channels on the rear face in fluid communication with a second channel port of the two channel ports, the melt flow channels comprising flow divider channels and spiral channels, the flow divider channels extending generally radially inward toward the inner face from the channel ports to terminate in the spiral channels, the spiral channels narrowing radially inward toward the inner face to terminate at the one or more outlets, each of the spiral channels substantially encircling the inner face; and, a thermal insulation layer within the distribution block between the front and rear faces separating all or part of the melt flow channels on the front face from all or part of the melt flow channels on the rear face.

22. The die of claim 21, wherein the thermal insulation layer is a generally annular fluid filled chamber.

23. The die of claim 22, wherein melted polymer from the front face is combined with melted polymer from the rear face before the polymer flows into the extrusion passage.
